(19) United States
(12) Patent Application Publication
(10) Pub. No.: US 2011/0100666 A1
(43) Pub. Date: May 5, 2011

(54) THERMALLY CONTROLLED, ANTI-SHOCK APPARATUS FOR AUTOMOTIVE ELECTRONICS

(76) Inventor: Albert T. Wu, Paramus, NJ (US)

(21) Appl. No.: 12/611,868

(22) Filed: Nov. 3, 2009

(51) Int. Cl. H02G 3/03; H01B 3/00

(52) U.S. Cl. 174/15.1; 174/17 R

(57) ABSTRACT

A thermally controlled, anti-shock apparatus for protecting an automotive electronic device. The apparatus includes a first housing having sidewalls that define an interior cavity. A second housing having a reservoir containing fluid is disposed within the interior cavity of the first housing. A sealed housing for carrying the electronic device is disposed within the fluid in the reservoir of the second housing, wherein the fluid provides buoyancy for keeping the sealed housing at least partially afloat within the reservoir. The sealed housing includes an inner fluid impermeable bag for enclosing the protected electronic device and an outer fluid impermeable bag in which the inner bag and electronic device are disposed. A cooling system condenser includes condenser tubing connected to one or more heat dissipating members that are mounted on a thermally conductive panel using one or more high strength magnets.

### BACKGROUND

1. Field of the Invention

This disclosure relates generally to automotive electronics and, more specifically, to providing a thermally controlled, anti-shock apparatus for protecting automotive electronics mounted within a vehicle.

2. Description of Related Art

For years, the automobile has proven to be an unusually harsh and punishing environment for all of its components, especially those that are electronic. Ever since the first radio was installed in an automobile, designing a way for electronics to withstand the extreme thermal conditions and excessive shock and vibration within an automobile has been a challenge.

When an automobile is traveling on the road, depending on the road condition, all components of the automobile, as well as the occupants, are subject to various degrees of shock and vibration. For instance, measurements indicate that in an ordinary car traveling over a 2-inch bump at 15 miles per hour, even with good functioning shock absorbers, the interior may register a 40 g shock as the peak value. This is substantially beyond the manufacturers' suggested shock limit of 1 g for a 2.5″ hard disk drive (HDD).

Vehicle shock absorption devices have been in service since dawn of the automotive industry. Although they have progressed continuously, such shock absorption devices are designed to target the comfort of the vehicle occupants. Since humans can tolerate the shock far better than consumer electronic devices, the shock absorbing system on an automobile is not adequate to foster the survival of the electronic devices.

Moreover, the interior of an automobile may experience extreme conditions during its operational life cycle. Depending on its location of operation, it may be subjected to temperatures ranging from −40° C. to +85° C. and, as mentioned above, vibrations exceeding 40 g. This is certainly not a friendly environment for any electronics of commercial or even industrial grade, especially a PC (personal computer), to operate within.

Accordingly, there is a need for a device for mounting electronic components in an automobile that is temperature controlled and provides shock absorbing capabilities to protect the electronic components from the extreme vibrations, shock and temperatures associated with normal operation of an automobile.

### BRIEF SUMMARY

In one aspect of this disclosure, a thermally controlled, anti-shock apparatus is disclosed for protecting an electronic device. The apparatus includes a first housing having sidewalls that define an interior cavity. A second housing having a reservoir containing fluid is disposed within the interior cavity of the first housing. A sealed housing for carrying the electronic device is disposed within the fluid in the reservoir of the second housing, wherein the fluid provides buoyancy for keeping the sealed housing at least partially afloat within the reservoir.

In another aspect of this disclosure, the thermally controlled, anti-shock apparatus includes a heating and cooling system for maintaining a predefined temperature within the interior cavity of the first housing. A condenser of the cooling system includes condenser tubing connected to one or more heat dissipating members that are mounted on a thermally conductive panel using one or more high strength magnets.

In another aspect of this disclosure, the sealed housing comprises an inner fluid impermeable bag for enclosing the protected electronic device and an outer fluid impermeable bag in which the inner bag and electronic device are disposed. An elastic member connects a corner of the outer fluid impermeable bag to an interior corner of the reservoir of the second housing to bias the sealed housing toward a neutral position within the reservoir of the second housing.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is an exploded perspective view of a preferred thermally controlled, anti-shock apparatus for protecting electronic components;

FIG. 2 is a partial cut away, perspective view of condenser tubing with heat dissipating members mounted on a body panel of an automobile for use with the apparatus of FIG. 1;

FIG. 3 is a cross-sectional view of the high pressure condenser tubing connected to a heat dissipating surface taken along line A-A of FIG. 2;

FIG. 4 is an exploded perspective view of an anti-shock container for use with the apparatus of FIG. 1; and

FIG. 5 is a perspective view illustrating the construction of a multi-layer, water resistant container bag for use with the anti-shock container of FIG. 4.

### DETAILED DESCRIPTION

This application discloses a preferred apparatus for protecting automotive electronics mounted within a vehicle from extreme temperature variations, shock and vibration associated with normal operation of the vehicle. The temperature control function and the anti-shock function are preferably seamlessly integrated together as one apparatus. The apparatus is both capable of isolating the shock and vibration substantially via mechanical means and providing a thermally controlled environment to protect electronic devices that reside inside this controlled domain from being damaged by the extreme temperatures due to seasonal change and the excessive shock generated by the road condition and transmitted through vehicle frame.

The apparatus creates a controlled space for protecting electronic components within the interior of an automobile. This controlled space is embodied within an apparatus with temperature-control and anti-shock capabilities. The apparatus may be mounted on the automobile frame and subjected to the punishing conditions that may occur inside an automobile. The temperature-control ability of the apparatus will preferably maintain the temperature within the controlled space within the operational range of a personal computer (PC). As far as vibration is concerned, the electronic device is preferably mechanically isolated from the frame as remote as possible and is a passive mechanical device that functions reasonably well by itself with or without being aided or controlled by an intelligent device such as CPU. The condition within this controlled space provides any resident electronic device near-isolation from both internal and external vibration sources so long as the vehicle is operating under normal design conditions.

The apparatus is preferably compact, will not intrude on current automobile design, and may be implemented at reasonable cost. The apparatus may fit within a compact space such that it can be mounted either inside the trunk or the passenger compartment of an automobile. In this case, it will provide the thermal condition and the shock isolation necessary for the onboard electronics without intruding on the interior design of the automobile.

As will be described below, the apparatus preferably comprises a thermally controlled container and a shock reduction container, which provides environmental control over a certain space such that it protects all electronic devices inside by subjecting them to only limited range of temperature variation and/or shock and vibration.

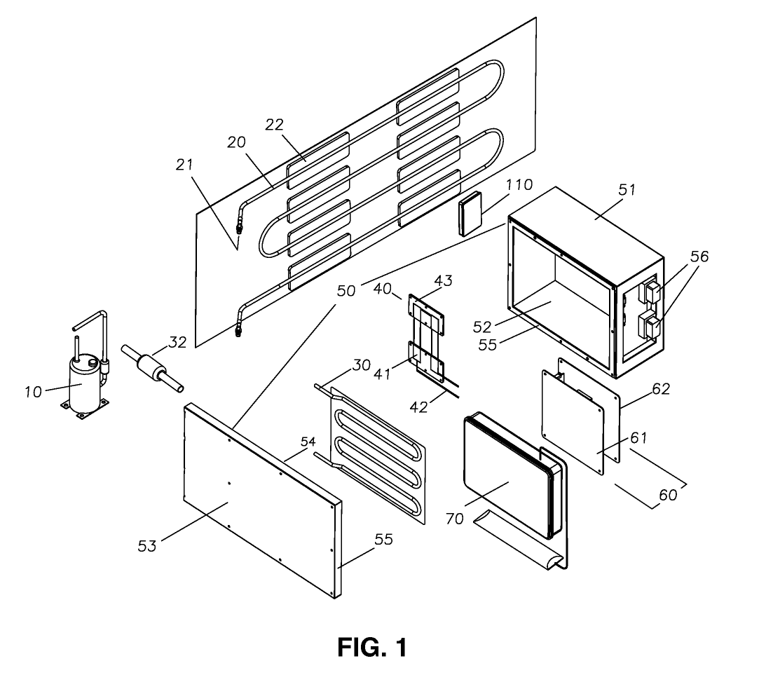

Referring to FIG. 1, the temperature controlled, anti-shock apparatus preferably includes a first housing or container 50 that functions to control temperature within an interior cavity of the first container and a second housing or container 70 disposed within the first container 50, which functions to control temperature and limit vibration.

First container 50 is preferably an insulated container for temperature control. First container 50 preferably includes a body that is configured as an open box having four sidewalls extending from a base to define an interior containing space or cavity. A lid preferably attaches to the first container 50 to enclose the interior containing space. The container body is preferably constructed with good insulating material 55 (such as fiberglass or the like) sandwiched between an outer layer 51 and an inner layer 52. The lid is also preferably constructed with insulating material 55 sandwiched between an outer layer 53 and inner layer 54. The lid may be permanently attached to the body during the period of operation.

The first container 50 preferably houses the functional components responsible for temperature control and vibration/shock reduction, as well as the electronic assemblies to be protected. For temperature control, a heating and cooling system may be employed to maintain a predefined or desired temperature within the interior space of the first and second containers 50, 70. The heating system may be, for example, an electric heating assembly and the cooling system may be, for example, a vapor-compression refrigeration system. An evaporator 30 of the cooling system and an electric heater assembly 40 of the heating system are preferably mounted inside container 50. The temperature control function of the apparatus is preferably a high efficiency device with coefficient of performance (COP) at 2.5 or better, and with smart algorithm loaded onto a built-in motor control unit (MCU) to regulate the best operational timing.

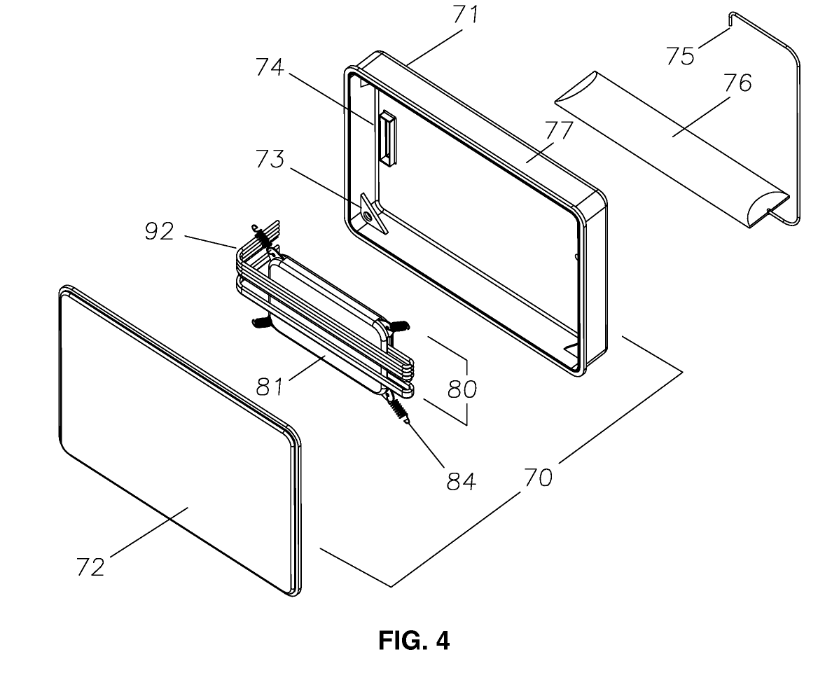

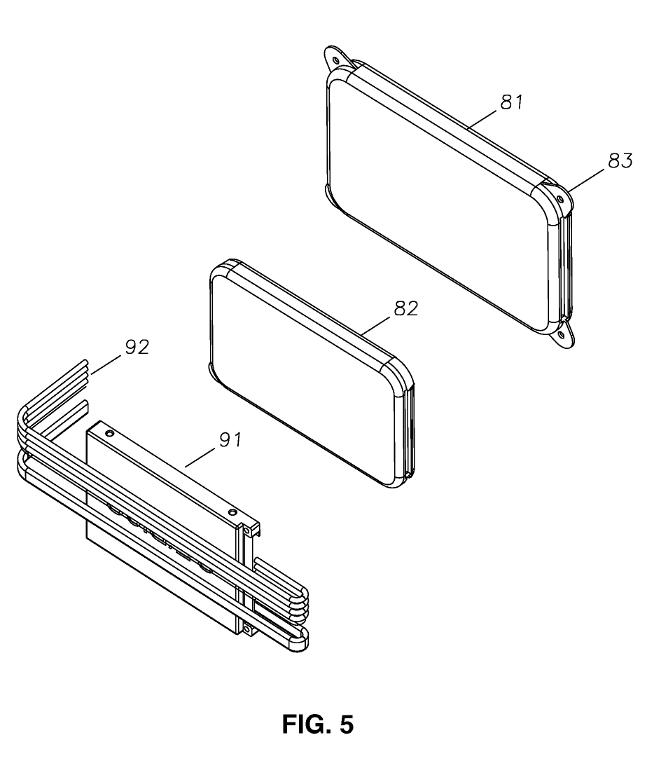

For shock reduction, the second housing or container 70, which is discussed further below with respect to FIGS. 4 and 5, is also located within the first housing or container 50. An electronic package 60, which includes an assembly(s) to be temperature protected, is also preferably mounted inside container 50.

The rest of the cooling system is preferably located outside the boundary of container 50. These cooling system components preferably include compressor assembly 10, pressure reduction valve 32, condenser assembly 20 and electronic temperature control assembly 110, which both supplies the power to and controls the on/off cycling of compressor 10.

Among all components of the cooling system, the condenser 10 takes up the most space and may be difficult to locate within the automobile. Accordingly, the preferred cooling system utilizes the auto body panel 100 itself as a heat dissipating surface. By doing so, it not only saves conductive radiator material, but it gives the cooling system freedom to be located in various sections of the auto body 100.

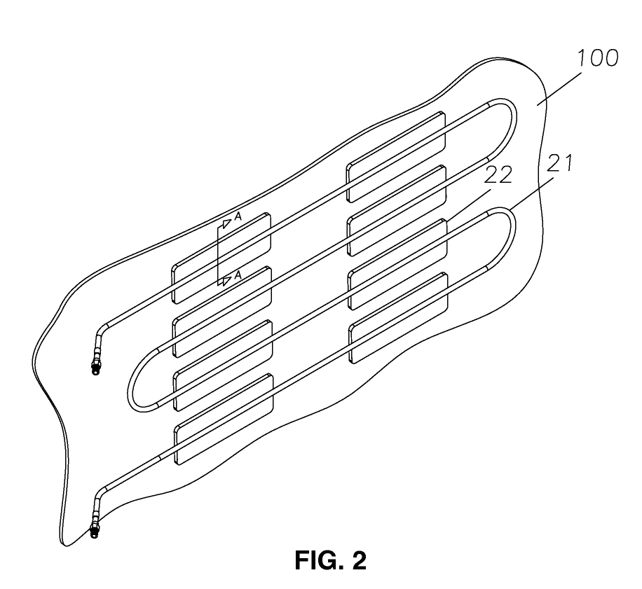

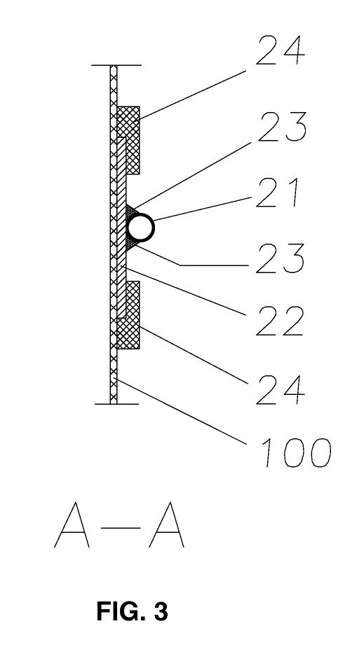

It is impractical to weld the condenser tubing 21 to the body surface 100 as doing so may damage the surface coating of the auto body and preclude installation of the apparatus in the aftermarket. Accordingly, a more preferred mounting method is illustrated in FIGS. 2 and 3.

FIG. 2 is a cut-away view of the high pressure condenser tubing 21 with a plurality of heat dissipating members 22 mounted on the auto body panel 100. A cross-section taken along line A-A of the tubing 21 and heat dissipating member 22 mounted on the body panel 100 of an automobile is illustrated in FIG. 3.

Condenser tubing 21 is preferably soldered or otherwise attached to heat dissipating member 22 with low temperature solder paste 23, because they are both made of copper. The heat dissipating member 22 should be securely attached to the auto body panel 100 to ensure good heat transfer property. In addition, a no heat or at least very low heat process should preferably be used to avoid damaging the surface coating of auto body panel 100. Therefore, a plurality of high strength magnets 24 are utilized to mount the condenser assembly 20 to the auto body panel 100. The high magnetic strength of these magnets 24 maintains each heat dissipating member 22 tightly against the auto body panel 100 to facilitate good heat dissipating thermal conduction from the condenser assembly 20 to the auto body panel.

Among the functional assemblies located within the first housing or container 50 is a second housing or container 70, which provides shock reduction function for components residing inside its interior reservoir. FIGS. 4 and 5 illustrate the preferred construction of the second housing or container 70.

This section of the disclosure starts with the following well-known formula covering force and motion, including vibration, in the field of “Classical Mechanics”:

f(t)=m*(d²x/dt²)+η*(dx/dt)+k*x

where:

m is the mass of the object under protection, a constant;

η is the damping coefficient of the environment, a constant;

k is the spring constant of the environment, a constant;

x is the position vector of the object, a time function;

dx/dt is the velocity vector of the object, a time function;

d²x/dt² is the acceleration vector of the object, a time function; and

f is the summation of the external force vectors applied to the system, a time function.

The objective of this section is to minimize the acceleration vector asserted onto the object under protection throughout the entire operation time span. Theoretically, there are several ways to achieve this goal.

Traditionally, the design was focused on damping, which may be achieved through employment of either friction between two surfaces or viscosity within a fluid. While fluid is employed, usually a labyrinth of passageways, in accordance with fluid viscosity, were crafted to provide restriction to the fluid flow in order to tune the damping factor.

This method may pose some disadvantage. For better damping effect, usually a high viscosity liquid, not gas, is selected. When the external force applied is in the form of low frequency and large displacement (amplitude) shock, the liquid may not make room fast enough such that, when the protected object runs into the liquid, it will have the same effect as running into a brick wall. This obviously fails the purpose of shock reduction.

Another method is to increase the mass m of the object to infinite. This will obviously reduce the acceleration d²x/dt² to zero. Although infinite mass m is not practical, this does point to a direction that increasing the mass can reduce the acceleration, thus the magnitude of vibration. This disclosure employs this approach only to a reasonable degree and much less essential comparing to the preferred option described below.

A third approach is to isolate the external force f from the object. While complete isolation is not achievable, to optimize it is a goal of this disclosure. The best way is to suspend the object in a liquid in a container that maintains a rigid link to the source of vibration.

The object of mass m carries a weight w, which is equivalent to m*g, in the earth gravitational field g. It will need support to suspend the object in a relatively stable position in the gravitational field.

If the support is in the form of rigid structure, then unfortunately the external forces can and will pass through it to cause acceleration and vibration on the object. Therefore, a new method of support, instead of a rigid structure, is desirable to prevent this from happening.

The choice is to use buoyancy B to counter the weight w. The formulae are:

w=m*g

B=ρ*V

where:

w is the weight of the object under protection;

m is the mass of the object under protection;

g is the earth gravitational acceleration (9.8 m/sec²);

B is the buoyancy the object under protection experienced;

ρ is the density of the fluid exterior to the object (including packaging material); and

V is the volume of the object (including packaging material).

When the proper design leads to B≈w, the object is nearly floating in the space surrounded by the fluid of density ρ. This eliminates the necessity of a rigid supporting structure, thus the opportunity to let the external force being substantially transmitted to the object.

The embodiment described below represents a practical and physical realization of the preferred method.

FIG. 4 illustrates an exploded perspective view of the shock reduction apparatus. The second housing or container 70 preferably includes a container body 71 and a lid 72. The container body 71 preferably includes a base from which upstanding walls project to define an interior space or reservoir. A watertight outlet 74 is preferably provided on a wall or base of the container body 71 through which an electric cable 92 of plural number of wires may pass. The lid 72 may then be mounted on or otherwise attached to the body 71 to enclose the interior space and form a watertight container 70.

External to the container 70, a bladder bag 76 is preferably in fluid communication with the interior/reservoir of the container 70 via a narrow tubing 75 that preferably passes through a hole or opening 77 in the container body 71. This bladder bag 76 helps container 70 avoid stress and deformation by taking and giving back the fluid from and to the container 70 when it experiences temperature variations.

An object to be protected, sealed housing assembly 80, is preferably located within the reservoir inside the second housing or container 70. By design, the sealed housing assembly 80 preferably floats, at least partially, within the fluid contained in the reservoir of second housing or container 70. In reality, even if the buoyancy and weight were exactly equal, displacement of the inner container 81 of the sealed housing 80 will occur in the case of large amplitude vibration suffered when the vehicle impacts a large obstacle. For this reason, some restraints are preferred to help the inner container 81 recover its neutral position. Therefore, a set of four elastic members 84 preferably connect the four corners of the inner container 81 to the interior four corners 73 of the reservoir in the second housing or container 70. These elastic members 84 are preferably very weak springs so that there will only be negligible amount of external force f(t) being allowed to pass through them onto the inner container 81. The spring constant of the elastic members 84 is a design parameter chosen in accordance with various design considerations.

FIG. 5 illustrates the inner container 81 of the sealed housing 80 and its contents. The innermost item is preferably a hard disc drive (HDD) 91 or other electronic device, which is the object to be protected from shock and vibration. An electrical cable 92 having a plurality of wires preferably extends from the HDD 91 in order to communicate with other devices located outside the second housing or container 70.

In order to achieve the best shock protection, HDD 91 is preferably mounted in such a way that its spinning axis is laid in horizontal position and its longitudinal axis is in parallel to the longitudinal axis of the vehicle. This arrangement will minimize the possibility of collision between the reader head and the high speed rotating disc of the HDD 91. And, the biggest shock may happen in the vertical direction when the vehicle hits a bump or pothole in the road surface on which it is traveling.

The vibration may come in two categories. One is high frequency, low amplitude. In this case, the amplitude is less than the free space between inner container 81 and the second housing or container 70. Therefore, due to the reciprocating nature of a vibration and the low amplitude comparing with the free space, there is no chance for inner container 81 to collide with second container 70. And, the force to hit container 81 (thus HDD 91) is no more than the friction of the passing liquid working on the surface of container 81.

If low frequency, high amplitude external vibration hits the system, the initial force container 81 may experience is still the friction the passing liquid asserted on its surface. However, since the amplitude exceeds the free space, container 81 does have a chance to collide with container 70. In this case, the friction mentioned above will reduce the relative approaching velocity significantly. And, the free space will provide ample time to make the acceleration event smaller. In addition, the air filled in container 81 for controlling the buoyancy also provides a cushioning affect to lessen the impact even further.

All in all, this combination will provide the best protection to the vibration sensitive HDD 91 at the lowest cost possible.

To contain and protect the HDD 91 from being flooded by the fluid that protects it from excessive shock and vibration, at least two layers of container are preferably used: an inner container 82 on the inner side and an outer container 81 on the outer side.

Outer container 81 is preferably a fluid impermeable bag, such as a plastic packaging bag or the like, submerged in the fluid contained in the reservoir of the second housing or container 70. The bias pressure of the fluid may assert considerable penetrating force on the outer container 81, as the penetrating force is proportional to the difference of the bias pressures on both sides of the barrier material. And, the material for outer container 81 can be neither too dense nor too thick, the necessary quality to resist penetrating force, lest to interfere with the shock protection. Therefore, after years of operation, a small amount of fluid may have a reasonable chance to penetrate into the interior of the outer container 81.

If any fluid comes into contact with HDD 91, that may spell disaster. More often than not, it will damage and disable HDD 91. So, an inner container 82 is preferably used to avoid this possibility.

Inner container 82, like outer container 81, is also preferably a fluid impermeable bag, such as a plastic packaging bag or the like. The volume of the inner container 82 is preferably smaller than the volume of the outer container 81 such that it leaves a reasonable air gap between its outer surface and the inner surface of container 81. So, if a small amount of fluid penetrates the interior of outer container 81 after years of operation, it will be retained within this air gap between containers 81 and 82. Within this gap, there is no bias fluid pressure buildup, and thus no penetrating force to push the fluid into the interior of inner container 82. This way, HDD 91 will be protected from fluid damage even after a long service life.

Containers 70, 81 and 82 (containing HDD 91) are all preferably located inside first housing or container 50. Therefore, they are all subjected to the temperature range maintained by container 50 and protected thermally, in addition to shock and vibration protection.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A thermally controlled, anti-shock apparatus for protecting an electronic device, comprising:
a first housing having sidewalls defining an interior cavity;
a second housing disposed within the interior cavity of the first housing, the second housing having a reservoir containing fluid; and
a sealed housing for carrying the electronic device, the sealed housing being disposed within the fluid in the reservoir of the second housing, wherein the fluid provides buoyancy for keeping the sealed housing at least partially afloat within the reservoir.

2. The thermally controlled, anti-shock apparatus of claim 1, wherein the first housing is insulated.

3. The thermally controlled, anti-shock apparatus of claim 1, further comprising a cooling system for cooling the interior cavity of the first housing.

4. The thermally controlled, anti-shock apparatus of claim 2, wherein the cooling system comprises an evaporator disposed within the interior cavity of the first housing.

5. The thermally controlled, anti-shock apparatus of claim 4, wherein the cooling system further comprises a condenser in fluid communication with the evaporator and disposed outside the interior cavity of the first housing.

6. The thermally controlled, anti-shock apparatus of claim 5, wherein the condenser comprises condenser tubing connected to one or more heat dissipating members.

7. The thermally controlled, anti-shock apparatus of claim 6, wherein the condenser tubing is soldered to the one or more heat dissipating members.

8. The thermally controlled, anti-shock apparatus of claim 6, wherein the one or more heat dissipating members are mounted on a thermally conductive panel.

9. The thermally controlled, anti-shock apparatus of claim 8, wherein the thermally conductive panel is part of the body of an automobile.

10. The thermally controlled, anti-shock apparatus of claim 8, wherein the one or more heat dissipating members are mounted on the thermally conductive panel using one or more magnets.

11. The thermally controlled, anti-shock apparatus of claim 10, wherein each heat dissipating member is mounted on the thermally conductive panel using a pair of magnets.

12. The thermally controlled, anti-shock apparatus of claim 10, wherein the one or more magnets are high strength magnets.

13. The thermally controlled, anti-shock apparatus of claim 3, further comprising a heating system for heating the interior cavity of the first housing.

14. The thermally controlled, anti-shock apparatus of claim 13, wherein the heating system comprises an electric heating element disposed within the interior cavity of the first housing.

15. The thermally controlled, anti-shock apparatus of claim 13, wherein the heating and cooling systems maintain a predefined temperature within the interior cavity of the first housing.

16. The thermally controlled, anti-shock apparatus of claim 1, wherein the sealed housing comprises a fluid impermeable bag for enclosing the protected electronic device.

17. The thermally controlled, anti-shock apparatus of claim 16, wherein the sealed housing comprises an inner fluid impermeable bag for enclosing the protected electronic device and an outer fluid impermeable bag in which the inner bag and electronic device are disposed.

18. The thermally controlled, anti-shock apparatus of claim 17, wherein the volume of the inner bag is smaller than the volume of the outer bag.

19. The thermally controlled, anti-shock apparatus of claim 1, further comprising an elastic member to bias the sealed housing toward a neutral position within the reservoir of the second housing.

20. The thermally controlled, anti-shock apparatus of claim 19, wherein an elastic member connects each side of the sealed housing to a side of the reservoir of the second housing.

21. The thermally controlled, anti-shock apparatus of claim 20, wherein the elastic member is a spring.

22. The thermally controlled, anti-shock apparatus of claim 16, wherein an elastic member connects a corner of the fluid impermeable bag to an interior corner of the reservoir of the second housing.

23. The thermally controlled, anti-shock apparatus of claim 16, further comprising at least one gas filled bag attached to the fluid impermeable bag to increase the buoyancy of the sealed housing and electronic device within the fluid in the reservoir of the second housing.

24. The thermally controlled, anti-shock apparatus of claim 16, further comprising a bladder disposed within the interior of the first housing, wherein the bladder is in fluid communication with the fluid in the reservoir of the second housing to accommodate volumetric change of the fluid incurred as a result of temperature variation.

25. The thermally controlled, anti-shock apparatus of claim 1, wherein the electronic device is a hard disc drive.

26. The thermally controlled, anti-shock apparatus of claim 1, wherein the apparatus is mounted in an automobile.
